(19) United States
(12) Patent Application Publication
(10) Pub. No.: US 2014/0075727 A1
(43) Pub. Date: Mar. 20, 2014

(54) UNDERCUT TOOL ASSEMBLY

(71) Applicant: Robert Cousineau, Ottawa (CA)

(72) Inventor: Robert Cousineau, Ottawa (CA)

(21) Appl. No.: 14/033,001

(22) Filed: Sep. 20, 2013

(30) Foreign Application Priority Data
Sep. 20, 2012 (CA) 2790948

(51) Int. Cl. B23P 17/04

(52) U.S. Cl. CPC B23P 17/04
USPC 29/33 R

(57) ABSTRACT

An undercut tool assembly utilizing a seismic drilling bit designed for insertion for use in enlarging an upper end of a pre-drilled hole for receiving and securely retaining an anchor therein. The bit is mounted onto a drill and has a pivot ring which permits limited tilting movement of the bit body during a drilling process to enlarge the lowermost end of the drill hole. The undercut tool assembly can be used in conjunction and locked engagement with a setting tool in a process to position an anchor in position within the bore hole. In this manner, an anchor can be inserted within the pre-drilled hole, and, when the anchor has been flanged outwardly by conventional means within the hole, the flange portions of the anchor will rest within the enlarged area, thus securely retaining the anchor in place.

### CLAIM OF PRIORITY

The present application for patent claims priority to Canadian Patent Application No. 2,790,948 entitled “Undercut Tool Assembly” filed Sep. 20, 2012, the entire disclosure of which is hereby expressly incorporated by reference herein.

### BACKGROUND

1. Field

The present invention relates to an undercut tool assembly meant to be used for the insertion and setting of anchors, such as drop-in and wedge type anchors, and, more particularly, the present invention relates to an undercut tool assembly for the insertion and setting of anchors into brittle materials such as concrete, stone, masonry and cementuous materials.

2. Background

Anchors are conventionally used in construction to attach various components of a building construction to an overhead ceiling or other structure. Such components to be attached can relate to, for example, services that provide plumbing, electrical, drainage, sprinkler system piping and drop ceilings. From these anchors, which are usually of the wedge or drop-in type variety, all of the above services and ceilings are suspended or secured.

Conventionally, in setting anchors in concrete to suspend an awning, for example, a hole is pre-drilled in the surface to which the anchor is to be applied, and then the anchor is inserted into the pre-drilled hole. However, when setting such anchors in concrete it is not uncommon for such anchors to weaken and loosen over time, particularly in situations where cracking or chipping of the concrete around the pre-drilled hole has occurred.

Furthermore, studies have revealed that cracking can typically occur in the concrete element, and that such cracks can significantly impact the performance of anchors. Cracks can originate on a concrete beam or slab in a variety of ways, such as creep, temperature settlement of the support or foundation, thermal expansion and contraction stress overload, or from a natural disaster such as an earthquake or flood. In such situations, the situation can arise where, if one such concrete anchor fails and lets go, the remaining anchors, by virtue of the weight they additionally assume in light of such failure, can also similarly collapse and fail.

It has been found that enlarging the lower part of the pre-drilled hole can allow for the use of anchors in a more secure manner. It has further been found that providing a drill hole with an enlarged lower end can be advantageously provided by a drill bit having an enlarged cutting portion adjacent the tip, which is inserted into the drilled hole, whereby the enlargement of the cutting portion is configured so that it can pass through the shaft of the drilled hole to the lower end to be enlarged.

It would therefore be advantageous to have an improved undercut tool assembly utilizing a seismic drilling bit meant for use in a pre-drilled hole for the insertion and setting of anchors into brittle materials such as concrete, stone, masonry and cementuous materials. It would also be advantageous to have a seismic drilling bit with side cutters on the bit head, when creating an undercut or tilting at the bottom of the borehole, to create an undercut after the drilling has occurred, as these added carbide cutters can extend the life of the drilling bit to reduce the friction and wear that conventional drilling bits would be exposed to.

It would be further advantageous to have an improved undercut tool assembly for use in a one step process for both creating a drill hole and, at the same time, enlarging a lowermost end of a drill hole, wherein an anchor can later be positioned and securely retained within the enlarged area.

It would be further advantageous to have an improved undercut tool assembly having an abutment portion with protective friction inserts to extend the life of the drill bit, and which can be used in conjunction with a setting tool in a process to position an anchor in position within the bore hole.

It would also be further advantageous to have an improved seismic drilling bit meant to be used for the later insertion and setting of anchors which utilizes a pivot ring for coming into contact with a surface being drilled and thus restricting downward movement of the seismic drill bit within the drill hole, the pivot ring having an outermost diameter greater than that of the drill hole and a remainder of the drill bit, whereby the pivot ring permits tilting movement of the bit body during a drilling process to enlarge the lowermost end of the drill hole. To this end, the present invention effectively addresses this need.

### SUMMARY

The present invention provides for an undercut tool assembly for effecting a drill hole and enlarging a lowermost end thereof for a later insertion and setting of anchors therein.

In a first aspect, the present embodiment provides an undercut tool assembly for effecting a drill hole and enlarging a lowermost end thereof for a later insertion and setting of anchors therein, the assembly comprising: a substantially cylindrical seismic drill bit sized to fit into the drill hole, the seismic drill bit having a upper end constructed and arranged to be operatively connected to a drill and a lower end having a drill tip head disposed generally opposite said upper end, wherein at least one cutting portion is positioned to protrude from the drill tip head, the at least one cutting portion having an operational cutting radius greater than a cutting radius of the seismic drill bit; a pivot ring on the seismic drill bit for coming into contact with a surface being drilled and thus restricting downward movement of the seismic drill bit within the drill hole, the pivot ring having an outermost diameter greater than that of the drill hole and a remainder of the seismic drill bit, whereby the pivot ring permits limited tilting movement of the seismic drill bit during a drilling process to enlarge the lowermost end of the drill hole; an abutment member on the seismic drill bit having a greater width than a remainder of the seismic drill bit; and a setting tool portion constructed and arranged to be operatively connected to the undercut tool assembly, the setting tool portion having a recessed area defined therein on an upper surface thereof for receiving and securing an insertion of the undercut tool assembly therein after the drill hole has been made.

In a second aspect, the present embodiment provides an undercut tool assembly for effecting a drill hole and enlarging a lowermost end thereof for a later insertion and setting of anchors therein, the assembly comprising: a substantially cylindrical seismic drill bit sized to fit into the drill hole, the seismic drill bit having an upper end constructed and arranged to be operatively connected to a drill and a lower end having a drill tip head disposed generally opposite said upper end, wherein at least one cutting portion is positioned to protrude from the drill tip head, the at least one cutting portion having an operational cutting radius greater than a cutting radius of the seismic drill bit; a pivot ring on the seismic drill bit for coming into contact with a surface being drilled and thus restricting downward movement of the seismic drill bit within the drill hole, the pivot ring having an outermost diameter greater than that of the drill hole and a remainder of the seismic drill bit, whereby the pivot ring permits limited tilting movement of the seismic drill bit during a drilling process to enlarge the lowermost end of the drill hole, and wherein the pivot ring further comprises a plurality of recessed areas defined internally thereof, comprising a longitudinally extending first chamber, a laterally extending groove channel and a longitudinally extending second chamber, each of the first chamber and the second chamber being in connection with the groove channel; an abutment member on the seismic drill bit having a greater width than a remainder of the seismic drill bit; and a setting tool portion constructed and arranged to be operatively connected to the undercut tool assembly, the setting tool portion having a recessed area defined therein on an upper surface thereof for receiving and securing an insertion of the undercut tool assembly therein after the drill hole has been made, wherein the upper setting tool portion further comprises a securing tab on an upper interior surface thereof, and wherein the pivot ring further comprises an abutment insert for inhibiting movement of the securing tab beyond the abutment insert, the securing tab being constructed and arranged for placement within and selective slidable movement along the groove channel to achieve either a locked position when the securing tab is abutting the abutment insert and an unlocked position in the first chamber.

### BRIEF DESCRIPTION OF THE DRAWINGS

The embodiments of the present invention will now be described by reference to the following figures, in which identical reference numerals in different figures indicate identical elements.

FIG. 1A is a front view of an embodiment of the undercut tool assembly of the present invention.

FIG. 1AA is a front view of an embodiment of the drill tip head of the undercut tool assembly of the present invention.

FIG. 1B is a side view of the embodiment of the undercut tool assembly of the present invention shown in FIG. 1A.

FIG. 2A is a front view of the undercut tool assembly of the present invention shown in FIGS. 1A and 1B, in position within a drill hole.

FIG. 2B is a side view of the setting tool portion which can be interconnected with the undercut tool assembly.

FIG. 2C is a side view of the undercut tool assembly of the present invention shown in FIG. 2A, in position and in an unlocked position, about to interconnected with the setting tool portion.

FIG. 3A illustrates the undercut tool assembly of the present invention shown in FIG. 2C, in position and in an unlocked position with the setting tool portion.

FIG. 3B illustrates the undercut tool assembly of the present invention shown in FIG. 3A, in a locked position with the setting tool portion.

### DETAILED DESCRIPTION

The invention will be described for the purposes of illustration only in connection with certain embodiments. However, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

The present invention consists of an improved undercut tool assembly utilizing a seismic drilling bit designed for insertion and use in enlarging an upper end of a pre-drilled hole for receiving and securely retaining an anchor therein. The drilling bit can be rotatably mounted onto a conventional drill, or, alternatively, in an alternative embodiment, onto an elongated mounting assembly, which in turn is rotatably mounted to a conventional drill.

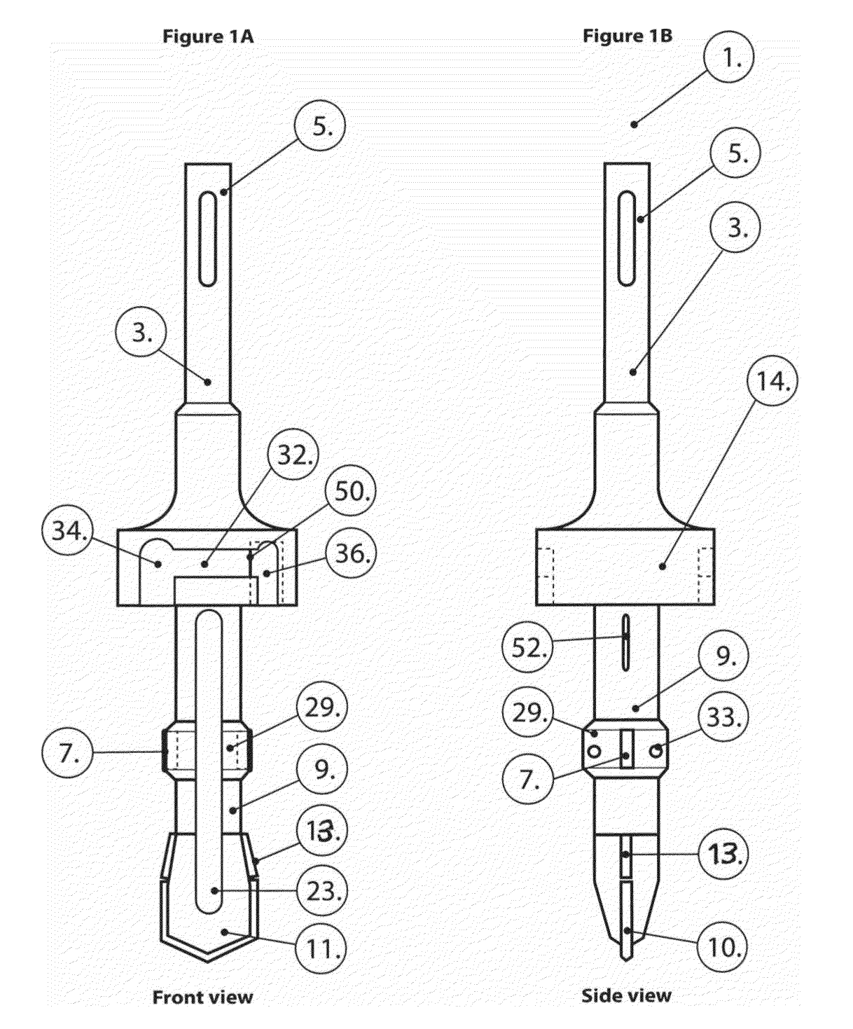

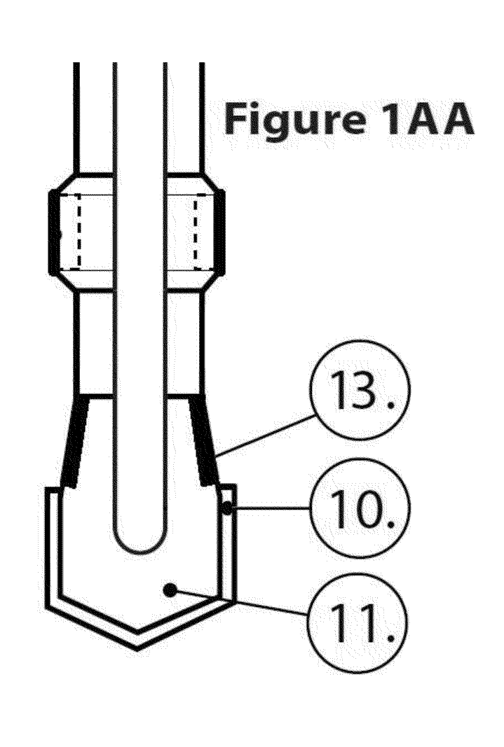

Referring to FIGS. 1A and 1B, there is shown an undercut tool assembly (utilizing a seismic drilling bit) shown generally at 1 in accordance with a first exemplary embodiment of the present invention, for use in the later insertion and setting of anchors into concrete, stone, masonry and cementuous materials. In a preferred embodiment, the proximal upper end 5 of the seismic drilling bit 3 is constructed and arranged to be releasably secured to a drill by way of a drill spindle (not shown). In this manner, the bit itself, without any other necessary parts, can be easily attached to a drill to effect the drilling of a drill hole and enlarging a lowermost end thereof, whereby an anchor can be set more securely therein.

Preferably, the seismic drilling bit 3 will be made of a durable, machinable metal and is substantially cylindrical in shape. The seismic drilling bit 3 is, preferably, of a one-piece construction that comprises an upper end 5 and a lower end 9 which are integrally connected to one another. The drilling bit 3 can also have a fluted body, or a non-fluted body.

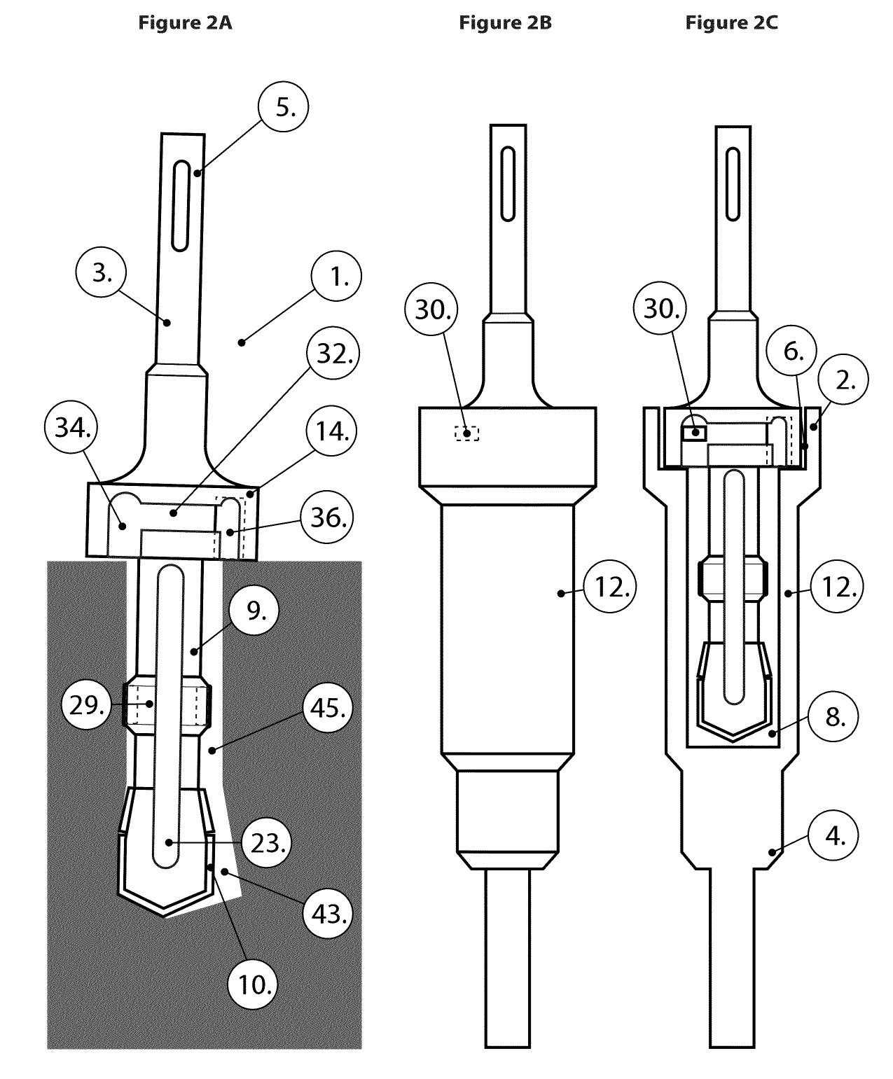

With reference to FIGS. 1A and 1B, it can be seen that the seismic drilling bit 3 can affect the drilling of a drill hole, and has a first diameter (and cutting radius) sized to readily fit into a drill hole 45, as shown in FIGS. 2A and 2B. The bit can, if desired, possess, as most conventional drill bits do, at least one cutting edge (not shown) and at least one groove (not shown) extending in a helical fashion along a length of the seismic drilling bit 3.

As best shown in FIGS. 1A and 1B, the lower end 9 of the seismic drilling bit 3 has a cutting portion 10 positioned on each side of the drill tip head 11 of the lower end 9 of the seismic drilling bit 3, the cutting portions 10 having a greater outermost width than that of the remainder of the seismic drilling bit 3 whereby, when the seismic drilling bit 3 is inserted fully into a lowermost end 43 of the drill hole 45 and rotated, the cutting portions 10 enlarge a circumference of the drill hole 45 at the lowermost end 43 thereof that is greater than the circumference of the remainder of the shaft of the drill hole 45. Preferably, the cutting portions are positioned on opposite sides of the lower end 9 of the seismic drilling bit 3, though it is conceivable that cutting portions 10 could extend outwardly from substantially around an entirety of the lower end 9 of the seismic drilling bit 3. A plurality of cutting portions 10 could also be utilized. By virtue of the seismic drilling bit 3 having cutting portions 10 (which could be, for example, carbide cutting tips), it provides a second cutting step to widen a lower end 43 of the pre drilled borehole 45. The lower end 9 of the seismic drilling bit 3 can also comprise wear indicator 52 (shown in FIG. 1B) to indicate if the tool is still in a good working condition. If the wear indicator 52 is not apparent, through repetitive use and wear due to frictionality, then the tool should be replaced. More than one wear indicator 52 could be used, if necessary.

In an alternative embodiment, the lower end 9 of the seismic drilling bit 3 could possess a quad cutting portion (not shown), as well as a cutting portion, positioned on each side of the lower end of the seismic drilling bit, the quad cutting portion having a greater outermost width than that of the remainder of the seismic drilling bit.

In another alternative embodiment, and with specific reference to FIG. 1AA, a wear insert 13 is present, flush with the upper outer face of the drill tip head 11. Said wear insert 13 can be a protective carbide insert and extends the life of the drill tip head 11 and cutting portions 10 by acting as a reinforcement means for drill tip head 11.

With reference to FIGS. 1A, 1B and 2A, the seismic drilling bit 3 further comprises a pivot ring 14. As shown in FIGS. 1A and 1B, when the drilling bit is used to effect a drilling hole 45 and is inserted further into the hole 45, the seismic drilling bit 3 (see FIG. 2A) can only be pushed downwardly to a certain point, at which the pivot ring 14 comes into contact with the surface being drilled, thus restricting further downward movement of the seismic drilling bit 3. Once the seismic drilling bit 3 is positioned into the hole 45, the seismic drilling bit 3 and pivot ring 14 can operably be rotated (by the user rotating the drill during the drilling process), as shown in FIG. 2A, to provide for wider rotation of the seismic drilling bit 3 inside the hole 45 with a view to enlarging a lowermost end 43 of the drill hole 45 to receive an anchor.

With reference to FIGS. 1A, 1B and 2A, the seismic drilling bit 3 further comprises an abutment portion 29. In an exemplary embodiment, the abutment portion 29 is positioned beneath the pivot ring 14 on the seismic drilling bit 3, and substantially lower than the pivot ring 14 while being slightly higher than the lower end 9 of the seismic drilling bit 3. By virtue of the abutment portion 29, the degree of rotation of the seismic drilling bit 3 is controlled during the drilling process, as the abutment portion 29 will contact a side wall of the hole 45 if the angle of rotation is too great, thus inhibiting any further rotation of the seismic drilling bit 3. In an alternative embodiment, the abutment portion 29 could also possess cutting portions 10 having a greater outermost width than that of the remainder of the abutment portion 29 and the seismic drilling bit 3.

In a further exemplary embodiment, with reference to FIGS. 1A and 1B, the abutment portion 29 will have friction protective inserts 7 on a surface thereof to reduce friction between the abutment portion 29 and the side wall of the drill hole 45, thus extending the life of the tool. These friction protective inserts 7 may surround the abutment portion 29, or may cover only a portion of it, or may cover partly half an outer surface thereof. The abutment portion 29 can also comprise wear indicators 33 (shown in FIG. 1B noted as dots) to indicate if the tool is still in a good working condition. If the wear indicators 33 are not apparent, through repetitive use and wear due to frictionality, then the tool should be replaced. In another exemplary embodiment, with reference to FIG. 1A, the abutment portion 29 does not extend completely around the seismic drilling bit 3. Rather a dust exit opening 23 is provided on sides of the abutment portion 29, whereby space is created to allow for drilling dust to exit out the top of the drill hole 45.

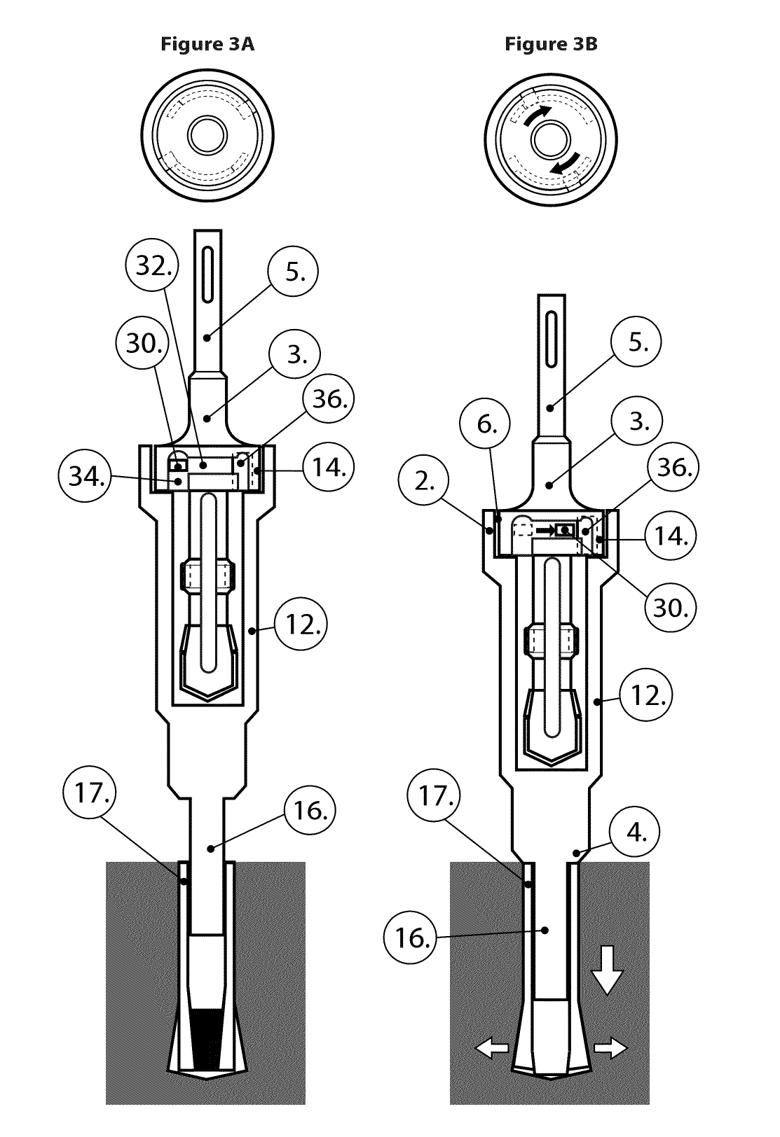

Further, with reference to FIGS. 1A and 2A, the pivot ring 14 also preferably has machined within a longitudinally extending first chamber 34, a longitudinally extending groove channel 32, and a longitudinally extending second chamber 36, each of the first chamber 34 and second chamber 36 being in connection with the groove channel, whereby the seismic drilling bit 3 can be inserted into a setting tool portion 12, as seen in FIGS. 2C, 3A and 3B, and as hereinafter described. A worker skilled in the relevant art would appreciate that an alternative embodiment of the pivot ring 14 could exist, whereby said pivot ring 14 is not comprised of a longitudinally extending first chamber 34, a longitudinally extending groove channel 32, and a longitudinally extending second chamber 36. Instead, the pivot ring 14 could be machined as a one piece unit onto the lower end 9 of the seismic drilling bit 3. This would eliminate dust that would collect in the aforementioned chambers 34, 36 and channel 32 from the drilling of the drill hole 45.

With reference to FIGS. 2B and 2C, the setting tool portion 12 will also preferably possess a securing tab 30 on an upper interior surface thereof, whereby, after the bore hole 45 has been created by the seismic drilling bit 3, the seismic drilling bit 3 can be inserted into the setting tool portion 12 for later placement of an anchor as hereinafter described. The setting tool portion 12 will have a substantially hollow upper end, consisting of a first recessed area 6 and a second interconnected recessed area 8, which are constructed and arranged for receiving the seismic drilling bit 3 therein. With reference to FIGS. 2C and 3B, the first recessed area 6 of the setting tool portion 12 possesses a greater width than that of the second recessed area 8, in much the same way an upper rim portion 2 of the setting tool portion 12 possesses a greater width than that of a lower portion 4 thereof. The upper rim portion 2 will surround a first recessed area 6 defined therein for receiving, and in abutment with, the greater width of the pivot ring 14 when the seismic drilling bit 3 is placed therein.

In connecting the seismic drilling bit 3 into the setting tool portion 12, the securing tab 30 is positioned within the longitudinally extending first chamber 34, as can be seen in FIG. 3A, and, by rotating the seismic drilling bit 3, the securing tab 30 slidably moves along groove channel 32, as can be seen in FIG. 3B. Rubber insert 50, as seen in FIG. 1A, is positioned on an upper interior surface of the pivot ring 14, so as to eventually abut and prevent further sliding movement of securing tab 30 beyond the rubber insert 50, and to protect the securing tab, from damage when the hammering/vibration type actions securing the anchor are effected. Once the securing tab 30 encounters the rubber insert 50 the device is in a locked position, securing the seismic drilling bit 3 to the setting tool portion 12. To disengage the seismic drilling bit 3 from the setting tool portion 12, the seismic drilling bit 3 can be rotated slightly in a counter direction to move the securing tab 30 slidably back along groove channel 32 and into the first chamber 34 to assume an unlocked position, and thus separate these components.

In operation, the seismic drilling bit 3 is to be rotatably mounted and connected onto a drill (not shown) by way of spindle 5, and the assembly is positioned over a surface where a drill hole is to be made. Once the seismic drilling bit 3 is sunk to a pre-set depth and rotated, rotational drilling (and tilted rotational drilling as previously described) by the seismic drilling bit 3 can then be effected in creating an enlarged area of the lowermost end of a drill hole. By virtue of pivot ring 14 the seismic drilling bit 3 (see FIG. 2A) can only be pushed downwardly to a certain point, at which the pivot ring 14 comes into contact with the surface being drilled, thus restricting further downward movement of the seismic drilling bit 3. Once the seismic drilling bit 3 is fully positioned into the hole 45, the seismic drilling bit 3 and pivot ring 14 can then operably be rotated (by the user rotating the drill during the drilling process), the pivot ring controlling the amount of rotational tilting during the drilling process, as shown in FIG. 2A, and providing for a greater range of rotation of the seismic drilling bit 3 inside the hole 45 with a view to enlarging a lowermost end 43 of the drill hole 45. It will also be understood that a shape of the pivot ring 14 could also be varied.

Of course, by virtue of the drill tip head 11 (or the quad cutting portion if utilized) having a greater outermost width (and operational cutting radius) than that of the seismic drilling bit 3, when the seismic drilling bit 3 is rotated, enlarges a circumference of the drill hole 45 at the lowermost end 43 (in creating the enlarged area). In this manner, once the enlarged area has been created, and the seismic drilling bit 3 removed from the drill hole, the anchor (not shown) can be inserted, and, when the anchors have been flanged outwardly by conventional means within the drill hole, the flange portions of the anchor can rest within the enlarged area, thus securely retaining the anchor in place.

Once the drill hole 45 has been created, the seismic drilling bit 3 is inserted into the setting tool portion 12, as previously described, and an anchor 17 is attached to an outmost end 16 of the setting tool portion 12, as shown in FIGS. 3A and 3B, whereby the proximal upper end 5 of the seismic drilling bit 3 is secured to a drill and then used to rotate and pull the interconnected seismic drill bit 3 and setting tool portion 12 upwardly within the drill hole 45, which forces the flange portions of anchor 17 outwardly, to secure into the undercut within drill hole 45, as shown in FIG. 3B, thus securely retaining the anchor 17 in place.

It will be apparent to those skilled in this art that various modifications and variations may be made to the embodiments disclosed herein, consistent with the present invention, without departing from the spirit and scope of the present invention.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

What is claimed is:

1. An undercut tool assembly for effecting a drill hole and enlarging a lowermost end thereof for a later insertion and setting of anchors therein, the assembly comprising:
a substantially cylindrical seismic drill bit sized to fit into the drill hole, the seismic drill bit having a upper end constructed and arranged to be operatively connected to a drill and a lower end having a drill tip head disposed generally opposite said upper end, wherein at least one cutting portion is positioned to protrude from the drill tip head, the at least one cutting portion having an operational cutting radius greater than a cutting radius of the seismic drill bit;
a pivot ring on the seismic drill bit for coming into contact with a surface being drilled and thus restricting downward movement of the seismic drill bit within the drill hole, the pivot ring having an outermost diameter greater than that of the drill hole and a remainder of the seismic drill bit, whereby the pivot ring permits limited tilting movement of the seismic drill bit during a drilling process to enlarge the lowermost end of the drill hole;
an abutment member on the seismic drill bit having a greater width than a remainder of the seismic drill bit; and
a setting tool portion constructed and arranged to be operatively connected to the undercut tool assembly, the setting tool portion having a recessed area defined therein on an upper surface thereof for receiving and securing an insertion of the undercut tool assembly therein after the drill hole has been made.

2. The undercut tool assembly as claimed in claim 1, wherein the drill tip head extends outwardly from substantially around an entirety of the lower end.

3. The undercut tool assembly as claimed in claim 1, wherein the drill tip head is positioned to protrude from the lower end, the drill tip head having an operational cutting radius greater than a cutting radius of the seismic drill bit.

4. The undercut tool assembly as claimed in claim 1, wherein the seismic drill bit is of a one-piece construction.

5. The undercut tool assembly as claimed in claim 1, wherein the lower end possesses a plurality of cutting regions.

6. The undercut tool assembly as claimed in claim 1, wherein the abutment portion is positioned beneath the pivot ring on the seismic drill bit.

7. The undercut tool assembly as claimed in claim 1, wherein the abutment portion is positioned substantially lower than the pivot ring and slightly above the lower end of the seismic drill bit.

8. The undercut tool assembly as claimed in claim 1, wherein the abutment portion further comprises wear indicators thereon.

9. The undercut tool assembly as claimed in claim 1, wherein the abutment portion further comprises friction protective inserts on a surface thereof to reduce friction between the abutment portion and side walls of the drill hole.

10. An undercut tool assembly for effecting a drill hole and enlarging a lowermost end thereof for a later insertion and setting of anchors therein, the assembly comprising:
a substantially cylindrical seismic drill bit sized to fit into the drill hole, the seismic drill bit having an upper end constructed and arranged to be operatively connected to a drill and a lower end having a drill tip head disposed generally opposite said upper end, wherein at least one cutting portion is positioned to protrude from the drill tip head, the at least one cutting portion having an operational cutting radius greater than a cutting radius of the seismic drill bit;
a pivot ring on the seismic drill bit for coming into contact with a surface being drilled and thus restricting downward movement of the seismic drill bit within the drill hole, the pivot ring having an outermost diameter greater than that of the drill hole and a remainder of the seismic drill bit, whereby the pivot ring permits limited tilting movement of the seismic drill bit during a drilling process to enlarge the lowermost end of the drill hole, and wherein the pivot ring further comprises a plurality of recessed areas defined internally thereof, comprising a longitudinally extending first chamber, a laterally extending groove channel and a longitudinally extending second chamber, each of the first chamber and the second chamber being in connection with the groove channel;
an abutment member on the seismic drill bit having a greater width than a remainder of the seismic drill bit; and
a setting tool portion constructed and arranged to be operatively connected to the undercut tool assembly, the setting tool portion having a recessed area defined therein on an upper surface thereof for receiving and securing an insertion of the undercut tool assembly therein after the drill hole has been made, wherein the upper setting tool portion further comprises a securing tab on an upper interior surface thereof, and
wherein the pivot ring further comprises an abutment insert for inhibiting movement of the securing tab beyond the abutment insert, the securing tab being constructed and arranged for placement within and selective slidable movement along the groove channel to achieve either a locked position when the securing tab is abutting the abutment insert and an unlocked position in the first chamber.

11. The undercut tool assembly as claimed in claim 1, wherein the seismic drill bit further comprises at least one wear indicator thereon.

12. The undercut tool assembly as claimed in claim 1, wherein the drill tip head further comprises a wear insert thereon.
